(19) United States
(12) Patent Application Publication
(10) Pub. No.: US 2025/0013340 A1
(43) Pub. Date: Jan. 9, 2025

(54) METHOD AND APPARATUS FOR INTERACTIVE CONTROL, DEVICE AND STORAGE MEDIUM

(71) Applicant: Beijing Zitiao Network Technology Co., Ltd., Haidian District (CN)

(72) Inventor: Jin Huang, Beijing (CN)

(21) Appl. No.: 18/747,181

(22) Filed: Jun. 18, 2024

(30) Foreign Application Priority Data
Jul. 3, 2023 (CN) 202310808222.5

(51) Int. Cl. G06F 3/0481; A63F 13/40

(52) U.S. Cl. CPC G06F 3/0481; A63F 13/40

(57) ABSTRACT

A method for interactive control includes displaying a virtual element moving towards a first virtual object in a virtual scene, the virtual element being generated based on a first action for the first virtual object; in response to the virtual element moving to a first range associated with the first virtual object, changing a moving direction of the virtual element based on orientation information associated with the first virtual object; determining a second virtual object in the virtual scene acted on by the virtual element acts, based on the changed moving direction of the virtual element; and applying a first effect to the second virtual object, wherein the first effect is determined based on the first action. In this way, the motion forms of the virtual elements in the virtual scene can be extended, thereby improving the user's interaction experience in the virtual scene.

### FIELD

Example embodiments of the present disclosure generally relate to the field of computers, and more particularly, to a method and apparatus for interactive control, device and computer readable storage medium.

### BACKGROUND

With the development of computer level, various forms of electronic devices can greatly enrich people's daily lives. For example, one may utilize the electronic device to perform various interactions in the virtual scene.

In some interactive scenarios, a user may attack various types of virtual objects, and such virtual objects may include, for example, virtual characters of other players, or intelligent objects in a virtual scene, such as non-player characters, duplicate monsters, and the like. It would be desirable to improve the interactive experience when interacting with these virtual objects.

### SUMMARY

In a first aspect of the present disclosure, there is provided a method for interactive control. The method includes: displaying a virtual element moving towards a first virtual object in a virtual scene, the virtual element being generated based on a first action for the first virtual object; in response to the virtual element moving to a first range associated with the first virtual object, changing a moving direction of the virtual element based on orientation information associated with the first virtual object; determining a second virtual object in the virtual scene acted on by the virtual element, based on the changed moving direction of the virtual element; and applying a first effect to the second virtual object, wherein the first effect is determined based on the first action.

In a second aspect of the present disclosure, there is provided an apparatus for interactive control. The apparatus includes: an element displaying module configured to display a virtual element moving towards a first virtual object in a virtual scene, the virtual element being generated based on a first action for the first virtual object; a direction changing module configured to change a moving direction of the virtual element based on orientation information associated with the first virtual object, in response to the virtual element moving to a first range associated with the first virtual object; an object determining module configured to determine a second virtual object in the virtual scene acted on by the virtual element, based on the changed moving direction of the virtual element; and an effect applying module configured to apply a first effect to the second virtual object, wherein the first effect is determined based on the first action.

In a third aspect of the present disclosure, there is provided an electronic device. The device includes at least one processing unit; and at least one memory coupled to the at least one processing unit and storing instructions for execution by the at least one processing unit that, when being executed by the at least one processing unit, cause the electronic device to implement the method of the first aspect.

In a fourth aspect of the present disclosure, there is provided a computer readable storage medium. The computer readable storage medium stores a computer program thereon, and the computer program is executable by a processor to implement the method in the first aspect.

It should be appreciated that the content described in this section is not intended to limit critical features or essential features of the embodiments of the disclosure, nor is it intended to limit the scope of the disclosure. Other features of the present disclosure will become readily appreciated from the following description.

### BRIEF DESCRIPTION OF THE DRAWINGS

The above and other features, advantages, and aspects of various embodiments of the present disclosure will become more apparent with reference to the following detailed description taken in conjunction with the accompanying drawings. In the drawings, the same or similar reference numerals denote the same or similar elements, wherein:

FIG. 1 illustrates a schematic diagram of an example environment in which embodiments of the present disclosure can be implemented;

FIG. 2A-FIG. 2C illustrate example interfaces in accordance with some embodiments of the present disclosure;

FIG. 3 illustrates a flowchart of a process for interactive control in accordance with certain embodiments of the present disclosure;

FIG. 4 illustrates a schematic structural block diagram of an apparatus for interactive control in accordance with certain embodiments of the present disclosure;

FIG. 5 illustrates a block diagram of a device in which various embodiments of the present disclosure can be implemented.

### DETAILED DESCRIPTION

The following will describe the embodiments of the present disclosure in more detail with reference to the accompanying drawings. Although some embodiments of the present disclosure are shown in the drawings, it should be understood that the present disclosure can be implemented in various forms and should not be construed as limited to the embodiments set forth herein. On the contrary, these embodiments are provided for a more thorough and complete understanding of the present disclosure. It should be understood that the drawings and embodiments of the present disclosure are provided for illustrative purposes only and are not intended to limit the scope of protection of the present disclosure.

It should be noted that the title of any section/subsection provided herein are not limiting. Various embodiments are described throughout herein, and any type of embodiment may be included in any section/subsection. Furthermore, embodiments described in any section/subsection may be combined in any manner with any other embodiments described in the same section/subsection and/or different sections/subsections.

In the description of the embodiments of the present disclosure, the term “including” and the like should be understood as non-exclusive inclusion, that is, “including but not limited to”. The term “based on” should be understood as “based at least in part on.” The term “one embodiment” or “the embodiment” should be understood as “at least one embodiment”. The term “some embodiments” should be understood as “at least some embodiments”. Other explicit and implicit definitions may also be included below. The terms “first”, “second”, etc. may refer to different or identical objects. Other explicit and implicit definitions may also be included below.

Embodiments of the present disclosure may relate to data of a user, acquisition and/or use of data, etc. These aspects are in accordance with the corresponding laws and regulations and related provisions. In embodiments of the present disclosure, all data collection, acquisition, processing, forwarding, use and the like are carried out under the user's awareness and confirmation. Accordingly, when implementing the embodiments of the present disclosure, the user should be informed of the types of data or information that may be involved, a usage range, a usage scenario, and the like in an appropriate manner according to relevant laws and regulations, and then authorization of the user is obtained. The specific informing and/or authorization manner may vary according to actual situations and application scenarios, and the scope of the present disclosure is not limited in this aspect.

In the present description and the embodiments, the personal information processing is performed on the basis of legality (for example, obtaining the consent of the subject of the personal information or being necessary for the fulfillment of a contract, etc.), and is performed only within a predetermined range or a predetermined stipulation. The user rejects personal information other than the necessary information required for processing the basic function, and the use of the basic function by the user will not be affected.

As mentioned briefly above, generally, a user may interact with various types of virtual objects, for example, a user may attack a virtual object using a variety of virtual props (e. g., various virtual props such as guns, bombs, knives, magic balls, etc.).

Accordingly, in a virtual scene, if a virtual object is attacked, it is generally necessary to present an effect under attack (for example, playing an action when being attacked, changing a survival state of the virtual object (reducing the life value), etc.). Conventionally, the presentation of effect under attack may also be avoided based on the virtual props and/or skills used by the virtual object under attack. In some scenarios, the virtual object may absorb or eliminate an attack by using a particular virtual prop or skill. For example, an attack may cause 10 points of damage to a life value of a virtual object, and the virtual object may reduce the damage to zero through a specific prop. In some scenarios, an attacked virtual object may rebound, through a particular virtual prop, the received attack proportionally to a virtual object that launches the attack. For example, a virtual object A is attacked by virtual object B, which may cause 10 points of damage to the life value of virtual object A. The virtual object A may make the attack to be rebounded to virtual object B through a particular virtual prop, and may cause 5 points of damage to the life value of virtual object B. In some aspects, the attacked virtual object may also attack other virtual objects based on damage corresponding to the attack. For example, a damage to a life value of another virtual object caused by a next attack launched by the attacked virtual object may be increased. However, the manners in which virtual props and/or skills are rebounded in these conventional approaches are relatively limited. This will make the interactive manners of the user when controlling the virtual object to execute actions generally simple, and affect user's interactive experience.

Embodiments of the present disclosure propose an interactive control scheme. According to various embodiments of the present disclosure, a virtual element moving towards a first virtual object in a virtual scene and being generated based on a first action for the first virtual object is displayed. In response to the virtual element moving to a first range associated with the first virtual object, a moving direction of the virtual element is changed based on orientation information associated with the first virtual object. A second virtual object in the virtual scene acted on by the virtual element is determined based on the changed moving direction of the virtual element. A first effect determined based on the first action is applied to the second virtual object. In this way, the motion forms of the virtual element in the virtual scene may be extended, thereby improving the user's interactive experience in the virtual scene.

Various example implementations of the solution will be further described in detail below with reference to the accompanying drawings. For explaining principles and ideas of embodiments of the present disclosure, some of the following descriptions will refer to the field of games. However, it will be understood that this is merely an example and is not intended to limit the scope of the present disclosure in any way. Embodiments of the present disclosure can be applied to various fields of simulation, emulation, virtual reality, augmented reality, and the like.

### Example Environment

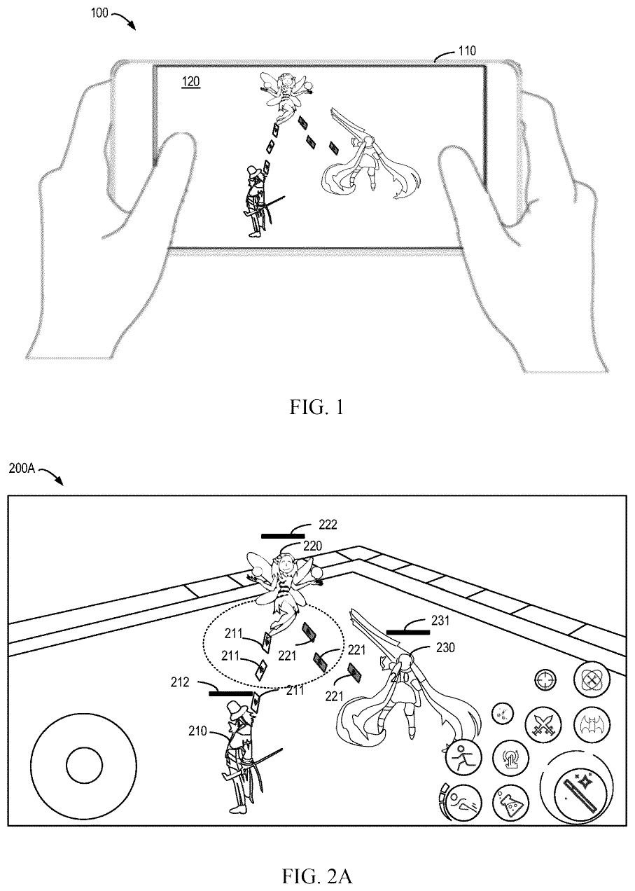

FIG. 1 illustrates a schematic diagram of an example environment 100 in which embodiments of the present disclosure can be implemented. The example environment 100 may include an electronic device 110. The electronic device 110 may include, for example, a suitable type of portable device that may support, for example, user's two-handed grip for various interactive operations. Such electronic devices 110 may include, for example but not limited to, smart phones, tablet computers, palmtops, portable game terminals, etc.

Such electronic devices 110 may include, for example, appropriate types of sensors for detecting user gestures. For example, the electronic device 110 may include, for example, a touch screen for detecting various types of gestures made by a user on the touch screen. Additionally or alternatively, the electronic device 110 may also include other suitable types of sensing devices, such as proximity sensors, to detect various types of gestures made by the user within a predetermined distance above the screen.

It should be understood that although the electronic device 110 is shown as a portable device in FIG. 1, it is merely an example. In still other embodiments, the electronic device 110 may also be of other suitable forms. For example, the electronic device 110 may include a display device for displaying and a computing device for computing, and the display device and the computing device can be physically coupled or separate, for example.

For example, the electronic device 110 may include a display screen for screen display, and a game console for screen rendering and game control.

In such scenarios, the electronic device 110 may, for example, utilize other suitable input devices to enable interaction. For example, the electronic device 110 may interact via a communicatively coupled interaction device such as a keyboard, mouse, joystick, game pad, etc.

Continuously referring to FIG. 1, the electronic device 110 may present a user interface 120, which can, for example, present a corresponding virtual environment. Exemplarily, the user interface 120 may be a game application interface, so as to present a corresponding game scene. Alternatively, the user interface 120 may also be another suitable type of interaction interface, and may support a user in controlling a virtual object in an interface to perform a corresponding action in a virtual environment.

It should be appreciated that the user interface 120 may be generated locally at the electronic device 110 or may be based on an image received by the electronic device 110 from a remote device (e. g., a cloud game host).

It should be appreciated that the structure and functionality of the environment 100 are described for exemplary purposes only and are not intended to imply any limitation on the scope of the disclosure.

### Example Interfaces

In order to represent the display control mechanism of the screens in the interface more intuitively, a game scene is taken as an example in the following description, and the embodiments of the present disclosure may enable the user to understand the corresponding screen display principle by presenting an example interface.

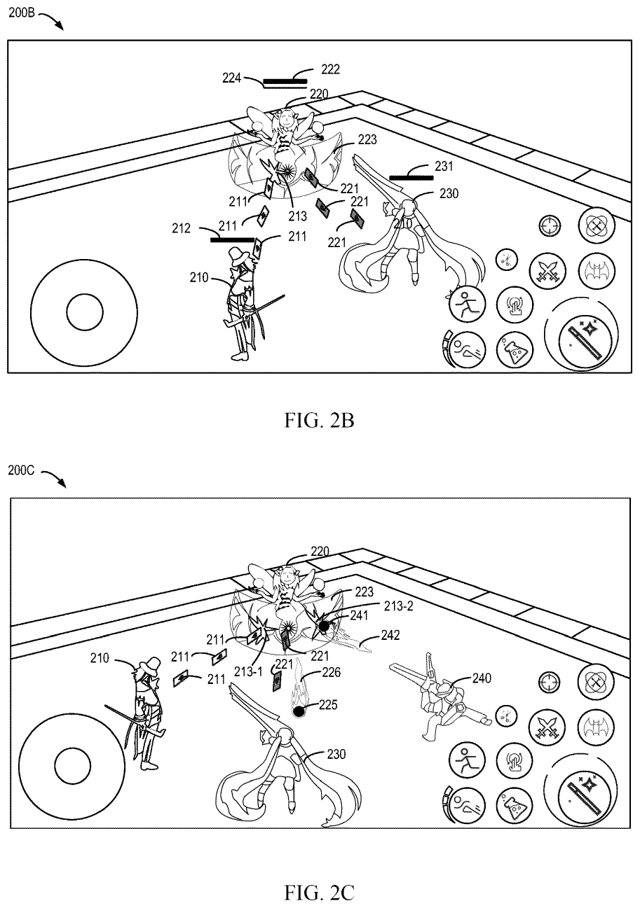

FIGS. 2A-2C illustrate schematic diagrams of example interfaces in accordance with some embodiments of the present disclosure. In some embodiments, the electronic device 110 may present the interfaces as shown in FIGS. 2A-2C upon receiving an interaction request for a virtual object. As introduced above, such an interface may include, for example, a graphical interface associated with a virtual scene. Such virtual scenes may include, for example, but are not limited to, various types of game scenes, simulation scenes, emulation scenes, etc.

As an example, the interfaces shown in FIGS. 2A-2C may be, for example, interactive interfaces that control a particular virtual object in a virtual scene (e. g., a battlefield) to fight (e. g., the target character controlled by the user is playing against an enemy). For example, a user may enter a control mode for the virtual object by performing a particular operation in the virtual scene or by clicking a particular button in the interface.

In the interfaces shown in FIGS. 2A-2C, the electronic device 110 may present at least one virtual object. The at least one virtual object includes, for example, a virtual article or character. In some embodiments, at least one virtual object may be associated with a user, which may be, for example, a virtual character that the user can manipulate, and typically has a particular attribute, skill, and appearance style. The electronic device 110 may control at least one virtual object to complete a task, engage in a confrontation, or unfold a storyline based on user operation. The electronic device 110 may perform various actions on other virtual objects by controlling the virtual object corresponding to the user through user operations, e. g., controlling the virtual object to perform actions on the other virtual objects such as normal attacks, releasing skill, etc.

In the interfaces shown in FIGS. 2A-2C, the electronic device 110 may also display at least one operating control associated with the virtual object. Such at least one operation control may be located, for example, at a specific position of the interface (for example, left and right sides, a lower side, and the like). In response to receiving a triggering operation on a target operation control in the at least one operation control, the virtual object corresponding to the user may be controlled to perform an action corresponding to the target operation control.

In an embodiment of the present disclosure, the electronic device 110 displays a virtual element moving towards a first virtual object in a virtual scene. The first action may be, for example, an attack action. The first virtual object is a virtual object attacked by the first action (namely, a virtual object being attacked). The virtual element herein is generated based on the first action for the first virtual object, and the number thereof may be at least one. In some embodiments, the virtual elements in the virtual scene include ballistic elements (e. g., bullets, magic balls, cards, etc.) that have a flight trajectory (which may also be referred to as an attack ballistic). In this case, the virtual element may indicate that a flight trajectory of the ballistic element directed towards the first virtual object, i. e., it may indicate a trajectory associated with the first virtual object. For example, when the virtual object A uses a gun to fire a bullet towards the virtual object B (since the virtual object A may fire continuously, there may be a plurality of bullets), the virtual object B is the first virtual object, and the attack action of the virtual object A firing a bullet is the first action for the virtual object B, and the virtual element moving towards the first virtual object in the virtual scene may include a bullet directed towards the virtual object B and a ballistic effect of the bullet presented in the virtual scene.

In response to the virtual element moving to a first range associated with the first virtual object, the electronic device 110 changes a moving direction of the virtual element based on the orientation information associated with the first virtual object. The changed moving direction of the virtual element may be associated with the orientation information of the first virtual object. The first range may be a fixed range set in advance. In some embodiments, the changed moving direction of the virtual element may be the same as the orientation information of the first virtual object. In some embodiments, the electronic device 110 may also determine a reflection angle between the changed moving direction and the orientation information of the first virtual object based on the moving direction before the virtual element changes and the orientation information of the first virtual object. Then, the electronic device 110 determines the changed moving direction of the virtual element based on the reflection angle.

Further, the electronic device 110 determines a second virtual object in the virtual scene acted on by the virtual element, based on the changed moving direction of the virtual element. The second virtual object is another virtual object different from the first virtual object. In some embodiments, the second virtual object may be a virtual object that performs the first action for the first virtual object. Exemplarily, if the virtual object A uses a gun to fire a bullet towards the virtual object B, after the bullet moves to the first range associated with the virtual object B, the moving direction changes based on the orientation information of the virtual object B. The changed moving direction may be, for example, a direction rebound back towards the virtual object A. In some embodiments, the second virtual object may also be a virtual object other than the virtual object performing the first action for the first virtual object. Exemplarily, if the virtual object A uses a gun to fire a bullet towards the virtual object B, after the bullet moves to the first range associated with the virtual object B, the moving direction changes based on the orientation information of the virtual object B. The changed moving direction may be a direction facing the virtual object C, for example.

The electronic device 110 applies a first effect determined based on the first action to the second virtual object. If the first action is an attack action, the first effect is an effect under attack corresponding to the attack action, where the first effect herein may be, for example, life value reduction, dizziness, rigidity, knockout, setback, and the like. Exemplarily, if the changed moving direction of the bullet fired by the virtual object A towards the virtual object B using a gun is the direction directed towards the virtual object C, the effect under attack by the bullet may be applied to the virtual object C, for example, the life value of the virtual object C may be reduced.

As shown in FIG. 2A, a virtual object 210 and a virtual object 220 are displayed in interface 200. A virtual element 211 (e. g., a card) that virtual object 210 launched towards virtual object 220 is displayed in interface 200A. In some embodiments, at least one virtual element 211 (e. g., a plurality of cards) is displayed in interface 200A. The virtual element 211 may be, for example, a skill released by virtual object 210 or a launched virtual prop. The virtual object 220 may be considered as a first virtual object.

It should be noted that, in a confrontation game scenario (for example, in a MOBA game scenario), a plurality of camps may exist in a virtual scenario. A virtual object in any camp can only attack other virtual objects in camps other than the one in which the virtual object is located. Thus, in some embodiments, the virtual object 210 that launches the virtual element 211 and the virtual object 220 which virtual element 211 is directed to correspond to different camps in the virtual scene.

In response to the virtual element 211 to moving to a first range associated with the virtual object 220, the electronic device 110 changes a moving direction of the virtual element 211 based on orientation information associated with the virtual object 220.

In some embodiments, the electronic device 110 may change by default the moving direction of the virtual element 221 directed towards the virtual object 220 and moving to the first range associated with the virtual object 220. In some embodiments, the electronic device 110 changes the moving direction of the virtual element 211 directed towards the virtual object 220 and moving to the first range associated with the virtual object 220, only if the virtual object 220 performs a target action.

In some embodiments, in response to a target operation of the user corresponding to the virtual object 220, the electronic device 110 may control the virtual object 220 to perform the target action. The target operation herein may be, for example, a prop use operation, a skill release operation, and so on. Correspondingly, the target action may be, for example, a prop use action, a skill release action, and so on. The target motion here may be a defense action. The electronic device 110 determines to change the moving direction of the virtual element 211 towards the virtual object 220, in response to the virtual object 220 performing the target motion.

It will be appreciated that, in response to an action duration reaching a predetermined length of time, or the virtual object 220 stopping performing the target action in response to the user operation, the electronic device 110 no longer changes the moving direction of the virtual element 211 moving towards the virtual object 220.

In some embodiments, the first range here may be, for example, a range in which a circle of a predetermined radius centered on the virtual object 220 is located, such as a circle range centered on the virtual object 220 shown in FIG. 2A. The electronic device 110 may determine to change the moving direction of the virtual element 211 towards the virtual object 220, in response to the virtual element 211 moving to the boundary of this range.

In some embodiments, the electronic device 110 may further define a range for triggering the virtual element 211 to change direction, that is, further define a range for triggering the virtual element 211 to change direction on the basis of the first range. In particular, the electronic device 110 may display a defense element associated with virtual object 220 in response to a second action associated with virtual object 220. The second action herein may be a target action executed by the virtual object 220 (namely, the prop use action and the skill release action described above), and may also be a protection action performed on the virtual object 220 by other virtual objects in the same camp as the virtual object 220 (for example, another virtual object releases a protection skill to the virtual object 220). The defense element herein may include, for example, a shield element, a shield cover element, etc. As shown in FIG. 2B, electronic device 110 may present a defense element 223 (e. g., shield) in interface 200B in response to the second action. The defense element 223 has a preset angular range (namely, an angular range to which the defense element 223 is oriented, and it may also be referred to as a defensive range), for example, 150 degrees right in front of the virtual object 220. It should be understood that, embodiments of the present disclosure do not limit specific style of the defense element.

In some embodiments, in response to the virtual element 211 moving to the first range associated with the virtual object 220 and the virtual element 211 matching the angular range, the electronic device 110 may change the moving direction of the virtual element 211 based on the orientation information associated with the virtual object 220. Exemplarily, in response to the virtual element 211 moving to the first range associated with the virtual object 220 and the angle range of the virtual element 211 is in the angle range of the defective element 223, the electronic device 110 may determine that a landing point of the virtual element 211 is a certain part of the defense element 223. The electronic device 110 then determines that the moving direction of the virtual element 211 can be changed.

In some embodiments, in response to the virtual element 211 moving to the first range associated with the virtual object 220 and the virtual element 211 not matching the angular range, the electronic device 110 may apply a second effect corresponding to the first action to the virtual object 220. Exemplarily, in response to the virtual element 211 moving to the first range associated with the virtual object 220 and the angular range of the virtual element 211 being in another range other than the angular range of the defense element 223, the electronic device 110 may determine that the landing point of the virtual element 211 is on a body of the virtual object 220 that the defense element 223 failed to protect (for example, behind the virtual object 220). Then, the electronic device 110 may apply a second effect associated with the virtual element 211 to the virtual object 220 (e. g., reducing the life value of the virtual object 220, stunning the virtual object 220, etc.).

In some embodiments, as shown in FIG. 2B, in order to intuitively present the landing point of the virtual element 211 to a user, the electronic device 110 may also display an attacked indictor element 213 in interface 200B, in association with defense elements 223. The attacked indicator element 213 may indicate contact of the virtual element 211 with the defense element 223, wherein a display position of the attacked indicator element 213 is determined based on a position where the contact occurs.

In some embodiments, the defense element 223 has a corresponding attribute value, which may also be referred to as a defense value, an endurance value, or the like. The electronic device 110 may determine an attribute value associated with the first action, that is, a damage value that the virtual element 211 could cause (that is, a numerical value corresponding to a degree of changing an attribute value of the virtual object 220 by a certain degree). For example, if the virtual element 211 can reduce a life value of the virtual object 220 by 100 points, the damage value of the virtual element 211 is 100 points. The electronic device 110 may compare the damage value with the defense value of the defense element. Specifically, in response to the damage value being less than the defense value, electronic device 110 may update the defense value of the defense element based on the damage value. For example, if the damage value of the virtual element 211 is 100 points and the defense value of the defense element 223 is 500 points, the electronic device 110 may update the defense value based on the damage value, and the updated defense value may be, for example, 400 points.

In some embodiments, electronic device 110 may stop displaying the defense elements 223 in response to the damage value reaching the attribute value of defense elements 223. Exemplarily, if the damage value of the virtual element 211 is 100 points and the defense value of the defense element 223 is 50 points, the electronic device 110 may determine that the virtual element 211 may break through the defense element 223, and the electronic device 110 stops displaying the defense element 223. In some embodiments, in this case, the electronic device 110 may present a corresponding special effect (e. g., a shattering special effect of the shield element) to prompt the user that the defense element 223 will not be displayed.

In some embodiments, the electronic device 110 may also stop displaying defense element 223 in response to a duration of defense element 223 reaching a threshold. The threshold herein may be preset (e. g., 10 seconds, 20 seconds, etc.) In some embodiments, the electronic device 110 may display a duration prompt element 224 in interface 200B to prompt the duration of the defense element 223. The electronic device 110 may decrease the length of the duration prompt element 224 in response to an increase in the duration of defense elements 223. Further, in response to the duration reaching the threshold, electronic device 110 stops displaying the duration prompt element 224 and the defense element 223.

It shall be noted that as long as the defense element 223 is still displayed, the electronic device 110 may change the moving direction of the virtual element 211 that is directed toward the virtual object 220, moving to the first range of the virtual object 220 and matching the angle of the defense elements 223.

Regarding the manner of change in the moving direction, in some embodiments, the electronic device 110 may determine the target orientation of the virtual object 220 based on orientation information associated with the virtual object 220. The target orientation herein may be, for example, a direction directly in front of the virtual object 220. In some embodiments, the electronic device 110 may change the moving direction of the virtual element 211 based on the target orientation such that the changed moving direction is identical to the target orientation, or the angular difference between the changed moving direction and the target orientation is less than a threshold. In particular, the electronic device 110 may determine a direction range based on the target orientation. This direction range may indicate a range of angular difference between the changed moving direction and the target orientation, e. g., plus or minus 10 degrees. This direction range may be represented as a sector with the target orientation as a centerline. The electronic device 110 may determine a direction from the direction range as the changed moving direction of the virtual element 211. In some embodiments, determining the direction from the direction range may be performed randomly or according to a certain rule (for example, from one side of the range to the other side). Compared to the manner in which the changed moving direction is made to be the same as the target orientation, determining the changed moving direction based on the direction range may make it possible that in the presence of a plurality of virtual elements, the plurality of virtual elements for which the moving directions were changed do not overlap. In this way, a user can intuitively view a plurality of virtual elements whose moving directions are changed, thereby improving user's interaction experience.

In some embodiments, the process of changing the moving direction of the virtual element 211 may be considered as a process in which the virtual element 211 is rebounded by the virtual object 220. In this case, the virtual element 211 has a same bullet trajectory style before and after the change in the moving direction. The bullet trajectory style may be, for example, a style of the trajectory of the virtual element 211 during the movement. The trajectory style may be the same, for example, the color of the trajectory during the movement may be the same.

In some embodiments, in order to distinguish the virtual elements 211 before and after the change in the moving direction, in response to the change in the moving direction, the electronic device 110 may further adjust the color of the virtual elements 211. As shown in FIG. 2, the virtual element 211 directed to the virtual object 220 is in a light color, and the virtual element 221 with changed moving direction is in a dark color, that is, they are different in color. Regarding the color of the virtual element 221 with changed moving direction, in some embodiments, the electronic device 110 may determine the color of the virtual element 221 with changed moving direction based on the color associated with the virtual object 220. Here, the color associated with the virtual object 220 may be, for example, the color of the virtual object 220 itself. In some embodiments, since different camps correspond to different colors (for example, taking two camps exist as an example, and the two camps may correspond to red and blue respectively), the color associated with the virtual object 220 may also be, for example, the color of the camp in which the virtual object 220 is located.

The electronic device 110 may determine, based on the moving direction of the virtual element 221 with changed moving direction, a virtual object in the virtual scene that is acted upon by the virtual element 221 with changed moving direction. This virtual object acted upon by the virtual element 221 with changed moving direction may also be referred to as a second virtual object. In some embodiments, the determination of the second virtual object acted on by the changed virtual element 221 does not depend on the third virtual object that makes the first action. That is, the determination of the second virtual object depends on the movement of the changed virtual element 221, and the determination logic is independent of the third virtual object that makes the first action. In some cases, the second virtual object may be a third virtual object that makes the first action; and in some other cases, the second virtual object may also be different from the third virtual object.

As shown in FIGS. 2A and 2B, a virtual object 230 may also be included in interfaces 200A and 200B. The electronic device 110 may determine that the virtual element 221 with changed moving direction is directed towards another virtual object 230 different from the virtual object 210. Alternatively, or additionally, in some embodiments, the virtual object acted upon by the virtual element 221 with changed moving direction may also be directly determined as the virtual object 210 that launches the virtual element 211. The following is illustrated exemplarily with a case in which the virtual element 221 with changed moving direction acts upon the virtual object 230.

The electronic device 110 may determine a first effect based on an action executed by the virtual object 210, and taking the action as an attack action as an example, the first effect is an effect under attack. The effect under attack may be, for example, reducing a life value, stun, knock out, etc.

As shown in FIG. 2A and FIG. 2B, a life bar corresponding to different virtual objects (e. g., life bars 212, 222, and 231) may also be included in the interface 200A and the interface 200B, and the life bar may indicate a life value of a corresponding virtual object. After the electronic device 110 determines that the virtual object acted upon by the virtual element 221 with changed moving direction is the virtual object 230, the length, color, etc. of the life bar 231 may be adjusted to indicate that the life value of the virtual object 230 is attacked and reduced.

In some embodiments, prior to applying the first effect to virtual object 230, the electronic device 110 also needs to determine whether the camp in which virtual object 230 is located is the same as the object in which virtual object 220 is located. It may be appreciated that the virtual element 221 with changed moving direction may be considered as an attack launched by the virtual object 220. Therefore, the virtual element 221 with changed moving direction causes an attack effect only on a virtual object in a camp different from that of the virtual object 220. It may be understood that the virtual object 230 and the virtual object 210 may be virtual objects in a same camp, or may be virtual objects in different camps (for example, in a case that more than two camps are included, the virtual objects 210, 220, and 230 may be in three different camps, respectively).

Regarding the manner of determining the first effect, in some embodiments, the electronic device 110 may change, based on the first action, an attribute value associated with the virtual object 230 by a first degree, as the first effect applied to the virtual object 230. The first action here is expected to change an attribute value associated with the virtual object 220 by a second degree. The first degree may be a value less than the second degree and determined based on the second degree. Here, the attribute value may be, for example, a life value, a dizziness duration, a back-off distance of the virtual object, and the like. The electronic device 110 may determine a second effect associated with the virtual element 211 and expected to act on the virtual object 220, where the second effect may be, for example, decreasing the life value of the virtual object 220 by 100 points. Then, the electronic device 110 may determine, based on the second effect, a first effect of the virtual element 221 with changed moving direction that acts on the virtual object 230. The first effect of the virtual element 221 with changed moving direction acting on the virtual object 230 may be, for example, reducing the life value of the virtual object 230 by 50 points. Alternatively and/or additionally, in some embodiments, the first effect and the second effect may be the same effect (i. e., the action of the virtual element 221 with changed moving direction performed on the virtual object 230 will reduce the life value of the virtual object 230 by 100 points), and/or the first effect may also be an effect that is larger than the second effect (e. g., the first effect of the virtual element 221 with changed moving direction acting on the virtual object 230 may be, for example, reducing the life value of the virtual object 230 by 200 point). The present disclosure is not limited in this regard.

In some embodiments, the electronic device 110 may also change the virtual elements from different virtual objects and directed towards the virtual object 220. As shown in FIG. 2C, a virtual object 240 may also be included in interface 200C.

The virtual object 210 and the virtual object 240 may perform an attack action to launch the virtual element 211 and the virtual element 241 to virtual object 220, respectively. In response to the virtual element 211 and/or the virtual element 241 moving to a first range of virtual object 220 and the moving directions matching the angular ranges of the defense element 223, electronic device 110 may present attacked indicator elements 213-1 and 213-2, respectively, at the contact locations with defense elements 223.

In a case that the defense element 223 is displayed, the electronic device 110 may change the movement directions of the virtual elements 211 and 241 based on the orientation information of the virtual object 220. In a case where it is determined that both the virtual element 221 with changed moving direction and the virtual element 225 with changed moving direction are directed to the virtual object 230, the electronic device 110 may determine an effect to be applied to the virtual object 230 and apply the effect to the virtual object 230 based on the attack effect corresponding to each of the virtual element 210 and the virtual element 241.

In addition, the interface 200C may also present the bullet trajectory 252 of the virtual element 240 and the bullet trajectory 226 of the virtual element 225 with changed moving direction. In some embodiments, the bullet trajectory style of the bullet trajectory 242 is the same as that of the bullet trajectory 226.

In conclusion, according to various embodiments of the present disclosure, a moving direction of a virtual element moving towards a virtual object can be changed, and motion forms of the movement of the virtual element in a virtual scene can be extended, thereby improving user's interaction experience in the virtual scene.

### Example Processes

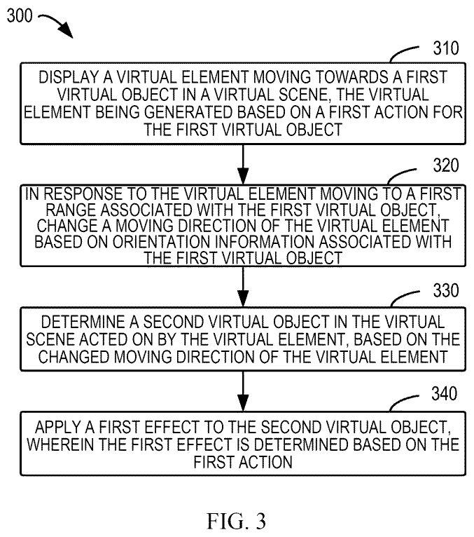

FIG. 3 illustrates a flowchart of a process 300 for interactive control in accordance with some embodiments of the disclosure. The process 300 may be implemented at the electronic device 110. The process 300 is described below with reference to FIG. 1.

In block 310, the electronic device 110 displays a virtual element moving towards a first virtual object in the virtual scene, the virtual element being generated based on a first action for the first virtual object.

In block 320, the electronic device 110 changes a moving direction of the virtual element based on orientation information associated with the first virtual object, in response to the virtual element moving to a first range associated with the first virtual object.

In block 330, the electronic device 110 determines a second virtual object in the virtual scene acted on by the virtual element, based on the changed moving direction of the virtual element.

In block 340, the electronic device 110 applies a first effect to the second virtual object, where the first effect is determined based on the first action.

In some embodiments, the virtual element has a same bullet trajectory style before and after the change in the moving direction.

In some embodiments, the process 300 further includes adjusting a color of the virtual element based on a color associated with the first virtual object, in response to the change in the moving direction.

In some embodiments, the orientation information associated with the first virtual object includes a target orientation of the first virtual object, and changing the moving direction of the virtual element includes changing the moving direction of the virtual element such that an angular difference between the changed moving direction and the target orientation is less than a threshold.

In some embodiments, changing the moving direction of the virtual element includes: determining a direction range based on the target orientation; and randomly determining a direction from the direction range as the changed moving direction of the virtual element.

In some embodiments, changing the moving direction of the virtual element based on the orientation information associated with the first virtual object includes: in response to a second action associated with the first virtual object, displaying a defense element associated with the first virtual object, the defense element having a preset angular range; and in response to the virtual element moving to the first range associated with the first virtual object and the virtual element matching the angular range, changing the moving direction of the virtual element based on the orientation information associated with the first virtual object.

In some embodiments, the process 300 further includes, in response to the virtual element moving to the first range associated with the first virtual object and the virtual element not matching the angular range, applying a second effect corresponding to the first action to the first virtual object.

In some embodiments, the process 300 further includes: in response to a first attribute value associated with the first action being less than a second attribute value of the defense element, updating the second attribute value based on the first attribute value; and in response to the first attribute value associated with the first action reaching the second attribute value of the defense element, stopping displaying the defense element.

In some embodiments, the process 300 further includes: in response to a duration of the defense element reaching the threshold, stopping displaying the defense element.

In some embodiments, the process 300 further includes: displaying an attacked indicator element in association with the defense element, to indicate contact of the virtual element with the defense element, wherein a display position of the attacked indicator element is determined based on a position where the contact occurs.

In some embodiments, applying the first effect to the second virtual object includes changing, based on the first action, a third attribute value associated with the second virtual object by a first degree, as the first effect applied to the second virtual object.

In some embodiments, the first action is expected to change a fourth attribute value associated with the first virtual object by a second degree, and the first degree is determined based on the second degree, and the first degree is less than the second degree.

In some embodiments, the first action is associated with a third virtual object in the virtual scene, and the second virtual object is determined independently of the third virtual object.

In some embodiments, the virtual element is a first virtual element associated with a third virtual object, the moving direction is a first moving direction, and the process 300 further includes: displaying a second virtual element moving towards the first virtual object, the virtual element being generated based on a third action of the fourth virtual object for the first virtual object, the third virtual object being different from the fourth virtual object; in response to the second virtual element moving to the first range associated with the first virtual object, changing a second moving direction of the second virtual element based on the orientation information associated with the first virtual object; determining a fifth virtual object in the virtual scene acted on by the second virtual element, based on the changed second moving direction of the second virtual element; and applying a second effect to the fifth virtual object, wherein the second effect is determined based on the third action.

In some embodiments, the first virtual object and the second virtual object correspond to different camps in the virtual scene.

In some embodiments, the virtual element is configured to indicate a bullet trajectory associated with the first virtual object.

### Example Apparatus and Devices

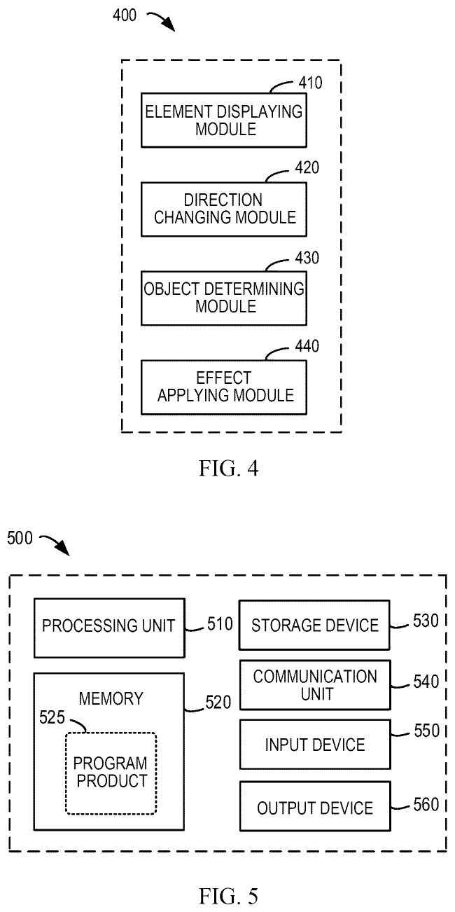

Embodiments of the present disclosure also provide corresponding apparatus for implementing the methods or processes described above. FIG. 4 illustrates a schematic structural block diagram of a content generation apparatus 400 according to certain embodiments of the present disclosure. The apparatus 400 may be implemented as or included in a terminal device 110 as discussed above. The various modules/components in the apparatus 400 may be implemented by hardware, software, firmware, or any combination thereof.

As shown in FIG. 4, the apparatus 400 includes an element displaying module 410 configured to display a virtual element moving towards a first virtual object in a virtual scene, the virtual element being generated based on a first action for the first virtual object. The apparatus 400 also includes a direction changing module 420 configured to change a moving direction of the virtual element based on orientation information associated with the first virtual object, in response to the virtual element moving to a first range associated with the first virtual object. The apparatus 400 also includes an object determining module 430 configured to determine a second virtual object in the virtual scene acted on by the virtual element, based on the changed moving direction of the virtual element. The apparatus 400 also includes an effect applying module 440 configured to apply a first effect to the second virtual object, wherein the first effect is determined based on the first action.

In some embodiments, the virtual element has a same bullet trajectory style before and after the change in the moving direction.

In some embodiments, the apparatus 400 further includes a color adjusting module configured to adjust a color of the virtual element based on a color associated with the first virtual object in response to the change in the moving direction.

In some embodiments, the orientation information associated with the first virtual object includes a target orientation of the first virtual object, and the direction changing module 420 includes a moving direction changing module configured to change the moving direction of the virtual element such that an angular difference between the changed moving direction and the target orientation is less than a threshold.

In some embodiments, the moving direction changing module includes: a direction range determining module configured to determine a direction range based on the target orientation; and a direction determining module configured to randomly determine a direction from the direction range as the changed moving direction of the virtual element.

In some embodiments, the direction changing module 420 comprises: a shield displaying module configured to display a defense element associated with the first virtual object in response to a second action associated with the first virtual object, the defense element having a preset angular range; and a second direction changing module configured to, in response to the virtual element moving to the first range associated with the first virtual object and the virtual element matching the angular range, change the moving direction of the virtual element based on the orientation information associated with the first virtual object.

In some embodiments, the apparatus 400 further includes a second effects applying module configured to apply, in response to the virtual element moving to the first range associated with the first virtual object and the virtual element not matching the angular range, a second effect corresponding to the first action to the first virtual object.

In some embodiments, the apparatus 400 further includes an attribute value updating module configured to update, in response to a first attribute value associated with the first action being less than a second attribute value of the defense element, the second attribute value based on the first attribute value; and a display stopping module configured to stop displaying the defense element, in response to the first attribute value associated with the first action reaching the second attribute value of the defense element.

In some embodiments, the apparatus 400 further includes a stopping module configured to stop displaying the defense element in response to a duration of the defense element reaching a threshold.

In some embodiments, the apparatus 400 further includes: an indication element displaying module configured to display an attacked indicator element in association with the defense element, to indicate contact of the virtual element with the defense element, wherein a display position of the attacked indicator element is determined based on a position where the contact occurs.

In some embodiments, the effect applying module 440 includes an attribute value changing module configured to change, based on the first action, a third attribute value associated with the second virtual object by a first degree, as the first effect applied to the second virtual object.

In some embodiments, the first action is expected to change a fourth attribute value associated with the first virtual object by a second degree, and the first degree is determined based on the second degree, and the first degree is less than the second degree.

In some embodiments, the first action is associated with a third virtual object in the virtual scene, and the second virtual object is determined independently of the third virtual object.

In some embodiments, the virtual element is a first virtual element associated with a third virtual object, the moving direction is a first moving direction. The apparatus 400 also includes a second element display module configured to display a second virtual element moving towards the first virtual object, the virtual element being generated based on a third action of the fourth virtual object for the first virtual object, the third virtual object being different from the fourth virtual object; a third direction changing module configured to, in response to the second virtual element moving to the first range associated with the first virtual object, change a second moving direction of the second virtual element based on the orientation information associated with the first virtual object; a second object determining module configured to determine a fifth virtual object in the virtual scene acted on by the second virtual element, based on the changed second moving direction of the second virtual element; and a third effect applying module configured to apply a second effect to the fifth virtual object, wherein the second effect is determined based on the third action.

In some embodiments, the first virtual object and the second virtual object correspond to different camps in the virtual scene.

In some embodiments, the virtual element is configured to indicate a bullet trajectory associated with the first virtual object.

FIG. 5 illustrates a block diagram of an electronic device 500 in which one or more embodiments of the present disclosure may be implemented. It should be appreciated that the electronic device 500 shown in FIG. 5 is merely exemplary and should not constitute any limitation on the functionality and scope of the embodiments described herein. The electronic device 500 shown in FIG. 5 may be used to implement the electronic device 110 in FIG. 1.

As shown in FIG. 5, the electronic device 500 is in the form of a general-purpose electronic device. Components of the electronic device 500 may include, but are not limited to, one or more processors or processing units 510, a memory 520, a storage device 530, one or more communications units 540, one or more input devices 550, and one or more output devices 560. The processing unit 510 may be an actual or virtual processor and can perform various processes according to programs stored in the memory 520. In a multiprocessor system, a plurality of processing units execute computer executable instructions in parallel, so as to improve the parallel processing capability of the electronic device 500.

The electronic device 500 typically includes a number of computer storage media. Such media may be any available media that are accessible by electronic device 500, including, but not limited to, volatile and non-volatile media, removable and non-removable media. The memory 520 may be a volatile memory (e. g., a register, cache, random access memory (RAM)), non-volatile memory (e.g., read-only memory (ROM), electrically erasable programmable read-only memory (EEPROM), flash memory), or some combination thereof. The storage device 530 may be a removable or non-removable medium and may include a machine-readable medium such as a flash drive, a magnetic disk, or any other medium that can be used to store information and/or data (e. g., training data for training) and that can be accessed within the electronic device 500.

The electronic device 500 may further include additional removable/non-removable, volatile/nonvolatile storage media. Although not shown in FIG. 5, a magnetic disk drive for reading from or writing to a removable, nonvolatile magnetic disk such as a “floppy disk” and an optical disk drive for reading from or writing to a removable, nonvolatile optical disk may be provided. In these cases, each drive may be connected to a bus (not shown) by one or more data media interfaces. The memory 520 may include a computer program product 525 having one or more program modules configured to perform various methods or actions of various embodiments of the present disclosure.

The communication unit 540 implements communication with other electronic devices through a communication medium. In addition, functions of components of the electronic device 500 may be implemented by a single computing cluster or a plurality of computing machines, and these computing machines can communicate through a communication connection. Thus, the electronic device 500 may operate in a networked environment using logical connections to one or more other servers, network personal computers (PCs), or another network node.

The input device 550 may be one or more input devices such as a mouse, keyboard, trackball, etc. The output device 560 may be one or more output devices such as a display, speaker, printer, etc. The electronic device 500 may also communicate with one or more external devices (not shown) such as a storage device, a display device, or the like through the communication unit 540 as required, and communicate with one or more devices that enable a user to interact with the electronic device 500, or communicate with any device (e. g., a network card, a modem, or the like) that enables the electronic device 500 to communicate with one or more other electronic devices. Such communication may be performed via an input/output (I/O) interface (not shown).

According to an exemplary implementation of the present disclosure, a computer readable storage medium is provided, on which a computer-executable instruction is stored, wherein the computer executable instruction is executed by a processor to implement the above-described method. According to an exemplary implementation of the present disclosure, there is also provided a computer program product, which is tangibly stored on a non-transitory computer readable medium and includes computer-executable instructions that are executed by a processor to implement the method described above.

Aspects of the present disclosure are described herein with reference to flowchart and/or block diagrams of methods, apparatus, devices and computer program products implemented in accordance with the present disclosure. It will be understood that each block of the flowcharts and/or block diagrams and combinations of blocks in the flowchart and/or block diagrams can be implemented by computer readable program instructions.

These computer readable program instructions may be provided to a processing unit of a general-purpose computer, special purpose computer, or other programmable data processing apparatus to produce a machine, such that the instructions, which execute via the processing unit of the computer or other programmable data processing apparatus, create means for implementing the functions/actions specified in one or more blocks of the flowchart and/or block diagrams. These computer readable program instructions may also be stored in a computer readable storage medium that can direct a computer, a programmable data processing apparatus, and/or other devices to function in a particular manner, such that the computer readable medium storing the instructions includes an article of manufacture including instructions which implement various aspects of the functions/actions specified in one or more blocks of the flowchart and/or block diagrams.

The computer readable program instructions may be loaded onto a computer, other programmable data processing apparatus, or other devices, causing a series of operational steps to be performed on a computer, other programmable data processing apparatus, or other devices, to produce a computer implemented process such that the instructions, when being executed on the computer, other programmable data processing apparatus, or other devices, implement the functions/actions specified in one or more blocks of the flowchart and/or block diagrams.

The flowcharts and block diagrams in the drawings illustrate the architecture, functionality, and operations of possible implementations of the systems, methods and computer program products according to various implementations of the present disclosure. In this regard, each block in the flowchart or block diagram may represent a module, segment, or portion of instructions which includes one or more executable instructions for implementing the specified logical function(s). In some alternative implementations, the functions marked in the blocks may occur in a different order than those marked in the drawings. For example, two consecutive blocks may actually be executed in parallel, or they may sometimes be executed in reverse order, depending on the function involved. It should also be noted that each block in the block diagrams and/or flowcharts, as well as combinations of blocks in the block diagrams and/or flowcharts, may be implemented using a dedicated hardware-based system that performs the specified function or operations, or may be implemented using a combination of dedicated hardware and computer instructions.

Various implementations of the disclosure have been described as above, the foregoing description is exemplary, not exhaustive, and the present application is not limited to the implementations as disclosed. Many modifications and variations will be apparent to those of ordinary skill in the art without departing from the scope and spirit of the implementations as described. The selection of terms used herein is intended to best explain the principles of the implementations, the practical application, or improvements to technologies in the marketplace, or to enable those skilled in the art to understand the implementations disclosed herein.

1. A method for interactive control, comprising:
displaying a virtual element moving towards a first virtual object in a virtual scene, the virtual element being generated based on a first action for the first virtual object;
in response to the virtual element moving to a first range associated with the first virtual object, changing a moving direction of the virtual element based on orientation information associated with the first virtual object;
determining a second virtual object in the virtual scene acted on by the virtual element, based on the changed moving direction of the virtual element; and
applying a first effect to the second virtual object, wherein the first effect is determined based on the first action.

2. The method of claim 1, wherein the virtual element has a same bullet trajectory style before and after the change in the moving direction.

3. The method of claim 1, further comprising:
in response to the change in the moving direction, adjusting a color of the virtual element based on a color associated with the first virtual object.

4. The method of claim 1, wherein the orientation information associated with the first virtual object comprises a target orientation of the first virtual object, and changing the moving direction of the virtual element comprises:
changing the moving direction of the virtual element such that an angular difference between the changed moving direction and the target orientation is less than a threshold.

5. The method of claim 4, wherein changing the moving direction of the virtual element comprises:
determining a direction range based on the target orientation; and
randomly determining a direction from the direction range as the changed moving direction of the virtual element.

6. The method of claim 1, wherein changing the moving direction of the virtual element based on the orientation information associated with the first virtual object comprises:
in response to a second action associated with the first virtual object, displaying a defense element associated with the first virtual object, the defense element having a preset angular range; and
in response to the virtual element moving to the first range associated with the first virtual object and the virtual element matching the angular range, changing the moving direction of the virtual element based on the orientation information associated with the first virtual object.

7. The method of claim 6, further comprising:
in response to the virtual element moving to the first range associated with the first virtual object and the virtual element failing to match the angular range, applying a second effect corresponding to the first action to the first virtual object.

8. The method of claim 6, further comprising:
in response to a first attribute value associated with the first action being less than a second attribute value of the defense element, updating the second attribute value based on the first attribute value; and
in response to the first attribute value associated with the first action reaching the second attribute value of the defense element, stopping displaying the defense element.

9. The method of claim 6, further comprising:
in response to a duration of the defense element reaching a threshold, stopping displaying the defense element.

10. The method of claim 6, further comprising:
displaying an attacked indicator element in association with the defense element, to indicate a contact of the virtual element with the defense element, wherein a display position of the attacked indicator element is determined based on a position where the contact occurs.

11. The method of claim 1, wherein applying the first effect to the second virtual object comprises:
changing, based on the first action, a third attribute value associated with the second virtual object by a first degree, as the first effect applied to the second virtual object.

12. The method of claim 11, wherein the first action is expected to change a fourth attribute value associated with the first virtual object by a second degree, and the first degree is determined based on the second degree, and the first degree is less than the second degree.

13. The method of claim 1, wherein the first action is associated with a third virtual object in the virtual scene, and the second virtual object is determined independently of the third virtual object.

14. The method of claim 1, wherein the virtual element is a first virtual element associated with a third virtual object, the moving direction is a first moving direction, and the method further comprises:
displaying a second virtual element moving towards the first virtual object, the virtual element being generated based on a third action of a fourth virtual object for the first virtual object, the third virtual object being different from the fourth virtual object;
in response to the second virtual element moving to the first range associated with the first virtual object, changing a second moving direction of the second virtual element based on the orientation information associated with the first virtual object;
determining a fifth virtual object in the virtual scene acted on by the second virtual element, based on the changed second moving direction of the second virtual element; and
applying a second effect to the fifth virtual object, wherein the second effect is determined based on the third action.

15. The method of claim 1, wherein the first virtual object and the second virtual object correspond to different camps in the virtual scene.

16. The method of claim 1, wherein the virtual element is configured to indicate a bullet trajectory associated with the first virtual object.

17. An electronic device, comprising:
at least one processing unit; and
at least one memory coupled to the at least one processing unit and storing instructions for execution by the at least one processing unit that, when being executed by the at least one processing unit, cause the electronic device to implement a method for interactive control, comprising:
displaying a virtual element moving towards a first virtual object in a virtual scene, the virtual element being generated based on a first action for the first virtual object;
in response to the virtual element moving to a first range associated with the first virtual object, changing a moving direction of the virtual element based on orientation information associated with the first virtual object;
determining a second virtual object in the virtual scene acted on by the virtual element, based on the changed moving direction of the virtual element; and
applying a first effect to the second virtual object, wherein the first effect is determined based on the first action.

18. The electronic device of claim 17, wherein the virtual element has a same bullet trajectory style before and after the change in the moving direction.

19. The electronic device of claim 17, the method further comprising:
in response to the change in the moving direction, adjusting a color of the virtual element based on a color associated with the first virtual object.

20. A computer readable storage medium having stored thereon a computer program, when being executed by a processor, the computer program implements method for interactive control comprising:
displaying a virtual element moving towards a first virtual object in a virtual scene, the virtual element being generated based on a first action for the first virtual object;
in response to the virtual element moving to a first range associated with the first virtual object, changing a moving direction of the virtual element based on orientation information associated with the first virtual object;
determining a second virtual object in the virtual scene acted on by the virtual element, based on the changed moving direction of the virtual element; and
applying a first effect to the second virtual object, wherein the first effect is determined based on the first action.
